(19) United States
(12) Patent Application Publication
(10) Pub. No.: US 2026/0100452 A1
(43) Pub. Date: Apr. 9, 2026

(54) CASE FOR SECONDARY BATTERY AND SECONDARY BATTERY INCLUDING THE SAME

(71) Applicant: SAMSUNG SDI CO., LTD., Yongin-si (KR)

(72) Inventor: Iloh SON, Yongin-si (KR)

(21) Appl. No.: 19/281,896

(22) Filed: Jul. 28, 2025

(30) Foreign Application Priority Data
Oct. 4, 2024 (KR) 10-2024-0134679

(51) Int. Cl. H01M 50/107; H01M 10/04; H01M 50/159; H01M 50/164

(52) U.S. Cl. CPC H01M 50/107; H01M 10/0431; H01M 50/159; H01M 50/164

(57) ABSTRACT

A case for a secondary battery includes a first case including a first body portion and a first fastening portion positioned at one end of the first body portion, a second case comprising a second body portion, a second fastening portion positioned at one end of the second body portion and configured to be coupled to the first fastening portion of the first case, and a third fastening portion positioned at an opposite end of the second body portion, and a third case including a third body portion and a fourth fastening portion positioned at one end of the third body portion and configured to be coupled to the third fastening portion of the second case.

### CROSS-REFERENCE TO RELATED APPLICATION

The present application claims priority to and the benefit under 35 U.S.C. § 119(a)-(d) of Korean Application No. 10-2024-0134679, filed on Oct. 4, 2024, in the Korean Intellectual Property Office, the entire disclosure of which is incorporated by reference herein.

### BACKGROUND

### Field

Aspects of embodiments of the present disclosure relate to a case for a secondary battery and a secondary battery including the same.

### Description of the Related Art

While primary batteries are not designed to be (re)charged, secondary (also known as rechargeable) batteries are batteries that are designed to be repeatedly discharged and recharged. Among secondary batteries, low-capacity secondary batteries are widely used in portable, small electronic devices, such as smart phones, feature phones, notebook computers, digital cameras, and camcorders, while high-capacity secondary batteries are widely used as power sources for driving motors in hybrid vehicles and electric vehicles, as well as for storing power (e.g., home and/or utility scale power storage). A secondary battery generally includes an electrode assembly including a positive electrode and a negative electrode, a case accommodating both electrodes, and electrode terminals connected to the electrode assembly.

After secondary batteries are manufactured, the secondary batteries may be disassembled so as to analyze the lifespan and characteristics thereof. Accurate analysis of electrode plates and cells may be impracticable due to damage that may occur to the electrode plates or cells during the disassembling process. In addition, for buffered cells, there is a risk of fire and/or explosion due to a hard short. Also, when disassembling a large number of cells, safety accidents may occur due to worker fatigue.

The information disclosed in this Background section is for enhancement of understanding of the background of the present disclosure. The section therefore may contain information that does not constitute related (or prior) art.

### SUMMARY

Aspects of embodiments of the present disclosure are directed to a case for a secondary battery. The case enables easy and safe disassembling work to be performed and prevents damage to the secondary battery.

These and other aspects and features of the present disclosure will be described in or will be apparent from the following description of embodiments of the present disclosure.

According to embodiments of the present disclosure, a case for a secondary battery may include a first case including a first body portion and a first fastening portion formed at one end of the first body portion, a second case comprising a second body portion, a second fastening portion formed at one end of the second body portion and fastened to the first fastening portion of the first case, and a third fastening portion formed at another end of the second body portion, and a third case including a third body portion and a fourth fastening portion formed at one end of the third body portion and fastened to the third fastening portion of the second case.

In an embodiment, a case for a secondary battery includes: a first case including a first body portion and a first fastening portion, the first fastening portion positioned at one end of the first body portion; a second case including a second body portion, a second fastening portion, the second fastening portion positioned at one end of the second body portion and configured to be coupled to the first fastening portion of the first case, and a third fastening portion, the third fastening portion positioned at an opposite end of the second body portion; and a third case including a third body portion and a fourth fastening portion, the fourth fastening portion formed at one end of the third body portion and configured to be coupled to the third fastening portion of the second case.

According to embodiments of the present disclosure, the first fastening portion may have a first thread structure, the second fastening portion may have a second thread structure corresponding to the first thread structure, and the first thread structure and the second thread structure may be fastened in a screw manner so that the first case and the second case are joined to each other.

In an embodiment, the first fastening portion has a first thread structure and the second fastening portion has a second thread structure corresponding to the first thread structure.

According to embodiments of the present disclosure, the third fastening portion may have a third thread structure, the fourth fastening portion may have a fourth thread structure corresponding to the third thread structure, and the third thread structure and the fourth thread structure may be fastened in a screw manner so that the second case and the third case are joined to each other.

In an embodiment, the third fastening portion has a third thread structure and the fourth fastening portion has a fourth thread structure corresponding to the third thread structure.

According to embodiments of the present disclosure, the second body portion may include a material that is different from materials of the first body portion and the third body portion.

In an embodiment, the second body portion includes a material different from materials of the first body portion and the third body portion.

According to embodiments of the present disclosure, a material of the first body portion may be different from a material of the first fastening portion, a material of the second body portion may be different from materials of the second fastening portion and the third fastening portion, and a material of the third body portion may be different from a material of the fourth fastening portion.

In an embodiment, the first body portion includes a material different from a material of the first fastening portion, the second body portion includes a material different from materials of the second fastening portion and the third fastening portion, and the third body portion includes a material different from a material of the fourth fastening portion.

According to embodiments of the present disclosure, the second body portion may include at least one of alloy tool steel, high-speed tool steel, powdered high-speed tool steel, cemented carbide, cold rolled steel plate, aluminum, aluminum alloy, or stainless steel.

In an embodiment, the second body portion includes at least one selected from the group of alloy tool steel, high-speed tool steel, powdered high-speed tool steel, cemented carbide, cold rolled steel plate, aluminum, aluminum alloy, and stainless steel.

According to embodiments of the present disclosure, the first fastening portion may include at least one of cold rolled steel plate, stainless steel, or tungsten.

In an embodiment, the first fastening portion includes at least one selected from the group of cold rolled steel plate, stainless steel, and tungsten.

According to embodiments of the present disclosure, the first fastening portion may be surface-coated with at least one of chromium, carbon, molybdenum, tungsten, or vanadium.

In an embodiment, the first fastening portion is surface-coated with at least one selected from the group of chromium, carbon, molybdenum, tungsten, and vanadium.

According to embodiments of the present disclosure, the third case may include a bottom portion that seals another end of the third body portion.

In an embodiment, the third case includes a bottom portion configured to seal an opposite end of the third body portion.

According to embodiments of the present disclosure, a secondary battery may include an electrode assembly include a first electrode, a second electrode, and a separator positioned between the first electrode and the second electrode, and a case configured to accommodate the electrode assembly, wherein the case may include a first case including a first body portion and a first fastening portion formed at one end of the first body portion, a second case including a second body portion, a second fastening portion formed at one end of the second body portion and fastened to the first fastening portion of the first case, and a third fastening portion formed at another end of the second body portion, and a third case including a third body portion and a fourth fastening portion formed at one end of the third body portion and fastened to the third fastening portion of the second case.

In an embodiment, a secondary battery includes: an electrode assembly comprising a first electrode, a second electrode, and a separator positioned between the first electrode and the second electrode; and a case configured to accommodate the electrode assembly, the case including: a first case including a first body portion and a first fastening portion, the first fastening portion positioned at one end of the first body portion; a second case including a second body portion, a second fastening portion, the second fastening portion positioned at one end of the second body portion and configured to be coupled to the first fastening portion of the first case, and a third fastening portion, the third fastening portion positioned at an opposite end of the second body portion; and a third case including a third body portion and a fourth fastening portion, the fourth fastening portion formed at one end of the third body portion and configured to be coupled to the third fastening portion of the second case.

According to embodiments of the present disclosure, the first fastening portion may have a first thread structure, the second fastening portion may have a second thread structure corresponding to the first thread structure, and the first thread structure and the second thread structure may be fastened in a screw manner so that the first case and the second case are joined to each other.

In an embodiment, the first fastening portion has a first thread structure and the second fastening portion has a second thread structure corresponding to the first thread structure.

According to embodiments of the present disclosure, the third fastening portion may have a third thread structure, the fourth fastening portion may have a fourth thread structure corresponding to the third thread structure of the third fastening portion, and the third thread structure and the fourth thread structure may be fastened in a screw manner so that the second case and the third case are joined to each other.

In an embodiment, the third fastening portion has a third thread structure and the fourth fastening portion has a fourth thread structure corresponding to the third thread structure of the third fastening portion.

According to embodiments of the present disclosure, the electrode assembly may be formed by winding the first electrode, the second electrode, and the separator with respect to a winding axis, the first electrode may include a first electrode tab formed to extend in a direction of the winding axis, and at least a portion of the first electrode tab may overlap the second fastening portion in a direction perpendicular to the winding axis.

In an embodiment, each of the first electrode, the second electrode, and the separator is in a wound configuration relative to a winding axis, wherein the first electrode comprises a first electrode tab extending in a direction of the winding axis, and wherein at least a portion of the first electrode tab overlaps the second fastening portion in a direction perpendicular to the winding axis.

According to embodiments of the present disclosure, the secondary battery may further include a cap assembly positioned on an opening formed at another end of the first body portion, wherein the first electrode tab may be in contact with the cap assembly.

In an embodiment, the secondary battery further includes a cap assembly positioned on an opening formed at an opposite end of the first body portion, wherein the first electrode tab is in contact with the cap assembly.

According to embodiments of the present disclosure, the electrode assembly may be formed by winding the first electrode, the second electrode, and the separator with respect to a winding axis, the second electrode may include a second electrode tab formed to extend in a direction of the winding axis, and at least a portion of the second electrode tab may overlap the third fastening portion in a direction perpendicular to the winding axis.

In an embodiment, each of the first electrode, the second electrode, and the separator is in a wound configuration relative a winding axis, wherein the second electrode comprises a second electrode tab extending in a direction of the winding axis, and wherein at least a portion of the second electrode tab overlaps the third fastening portion in a direction perpendicular to the winding axis.

According to embodiments of the present disclosure, the third case may include a bottom portion formed at another end of the third body portion and the second electrode tab may be in contact with the bottom portion.

In an embodiment, the third case comprises a bottom portion formed at an opposite end of the third body portion wherein the second electrode tab is in contact with the bottom portion.

According to embodiments of the present disclosure, the second body portion may include at least one of alloy tool steel, high-speed tool steel, powdered high-speed tool steel, cemented carbide, cold rolled steel plate, aluminum, aluminum alloy, or stainless steel.

In an embodiment, the second body portion includes at least one selected from the group of alloy tool steel, high-speed tool steel, powdered high-speed tool steel, cemented carbide, cold rolled steel plate, aluminum, aluminum alloy, and stainless steel.

According to embodiments of the present disclosure, the second case may be film-coated.

According to embodiments of the present disclosure, the first fastening portion may include at least one of cold rolled steel plate, stainless steel, or tungsten.

In an embodiment, the first fastening portion includes at least one selected from the group of cold rolled steel plate, stainless steel, and tungsten.

According to embodiments of the present disclosure, the first fastening portion may be surface-coated with at least one of chromium, carbon, molybdenum, tungsten, or vanadium.

In an embodiment, the first fastening portion is surface-coated with at least one selected from the group of chromium, carbon, molybdenum, tungsten, or vanadium.

According to various embodiments of the present disclosure, because the secondary battery includes a three-stage screw-fastened case for a secondary battery, the disassembling work of the secondary battery may be readily and safely performed and damage to the electrode assembly and the secondary battery itself may be prevented.

According to various embodiments of the present disclosure, because the secondary battery includes a three-stage screw-fastened case for a secondary battery, the disassembling operation of the secondary battery may be performed efficiently, and thus, deformation caused in a case where the electrode assembly is exposed to the outside may be prevented.

According to various embodiments of the present disclosure, it is possible to set optimal conditions required for disassembling analysis of the secondary battery by controlling the length or thickness between the components of the secondary battery.

According to various embodiments of the present disclosure, because the electrode tab included in the electrode assembly is positioned near the fastening portion of the case, the electrode tab may be cut when disassembling the secondary battery.

### BRIEF DESCRIPTION OF DRAWINGS

The following drawings attached to this specification illustrate embodiments of the present disclosure, and describe aspects and features of the present disclosure together with the detailed description of the present disclosure. The present disclosure is not limited to embodiments depicted in the drawings:

FIG. 1 shows a secondary battery according to embodiments of the present disclosure.

FIG. 2 shows a cap assembly of the secondary battery according to embodiments of the present disclosure.

FIG. 3 shows a case of the secondary battery according to embodiments of the present disclosure.

FIG. 4 shows a portion of the case according to embodiments of the present disclosure.

FIG. 5 shows a portion of the case according to embodiments of the present disclosure.

FIG. 6 shows a portion of the case according to embodiments of the present disclosure.

FIG. 7 shows a secondary battery according to embodiments of the present disclosure.

FIG. 8 is an exploded perspective view of a secondary battery including a case according to embodiments of the present disclosure.

FIG. 9 is a toughness-wear resistance graph of materials according to embodiments of the present disclosure.

FIG. 10 is an SN curve of materials according to embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as being consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of” A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements. In addition, it will be understood that when a component is referred to as being “linked,” “coupled,” or “connected” to another component, the elements may be directly “coupled,” “linked” or “connected” to each other, or another component may be “interposed” between the components”.

Numerical ranges disclosed and/or recited herein include all sub-ranges of the same numerical precision subsumed within the recited ranges. For example, a range of “1.0 to 10.0” includes all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein includes all lower numerical limitations subsumed therein, and any minimum numerical limitation recited in this specification includes all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

Terms used herein describe embodiments of the present disclosure and do not limit the present disclosure.

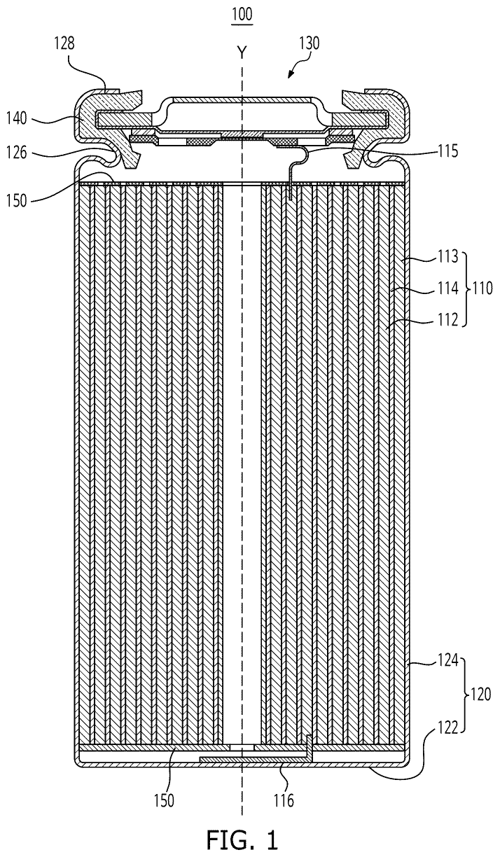

FIG. 1 shows a secondary battery 100 according to embodiments of the present disclosure.

The secondary battery 100 may include an electrode assembly 110, a case 120 that accommodates the electrode assembly 110 and an electrolyte contained in the secondary battery 100, a cap assembly 130 coupled with an opening of the case 120 to seal the case 120, and an insulating plate 150 positioned between the electrode assembly 110 and the cap assembly 130 within the case 120 and an insulating plate 150 positioned between the electrode assembly 110 and the bottom portion 122 within the case 120.

The electrode assembly 110 may include a separator 114, and a first electrode 112 and a second electrode 113, where the separator 114 is positioned between the first electrode 112 and the second electrode 113. The electrode assembly 110 may be wound in a jelly-roll shape relative to a winding axis Y.

The first electrode 112 may include a first substrate and a first active material layer positioned on the first substrate. In a first uncoated portion of the first substrate, where the first active material layer is absent, a first electrode tab 115 may extend from one end of the first uncoated portion in the direction of the winding axis Y. The first electrode tab 115 may be in contact with the cap assembly 130 and electrically connected to the cap assembly 130.

The second electrode 113 may include a second substrate and a second active material layer positioned on the second substrate. In a second uncoated portion of the second substrate, where the second active material layer is absent, a second electrode tab 116 may extend from one end of the second uncoated portion in the direction of the winding axis Y. The second electrode tab 116 may be in contact with a bottom portion 122 of the case 120 and electrically connected to the case 120. The first electrode tab 115 and the second electrode tab 116 may extend in opposite directions.

The first electrode 112 may function as a positive electrode. As a positive electrode, the first substrate may include, as a non-limiting example, aluminum foil, and the first active material layer may include, as a non-limiting example, a transition metal oxide. The second electrode 113 may function as a negative electrode. As a negative electrode, the second substrate may include, as a non-limiting example, copper foil or nickel foil, and the second active material layer may include, as a non-limiting example, graphite.

The separator 114 is configured to prevent a short circuit from occurring between the first electrode 112 and the second electrode 113 while allowing migration of lithium ions. The separator 114 may include, as a non-limiting example, a polyethylene film, a polypropylene film, a polyethylene-polypropylene film, and the like.

The case 120 may form the exterior of the secondary battery 100 together with the cap assembly 130. The case 120 may include a sidewall portion 124 having a substantially cylindrical shape and a bottom portion 122 connected to one longitudinal side of the sidewall portion 124. A beading portion 126 substantially cylindrically protruding toward the winding axis Y may exist on the sidewall portion 124, and a clamping portion 128 substantially cylindrically bent toward the winding axis Y may exist on the opening side end of the sidewall portion 124.

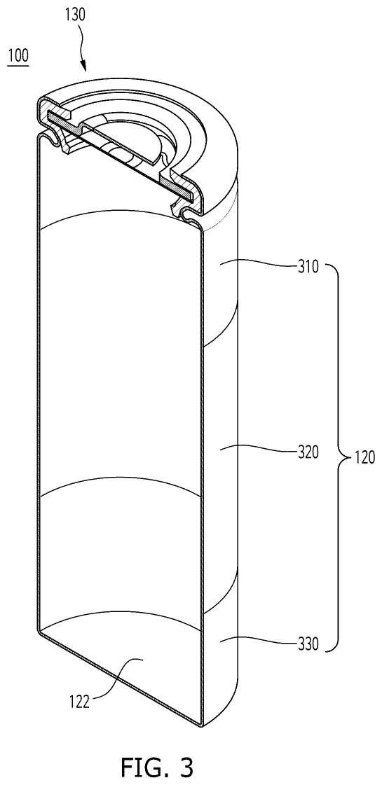

In an embodiment, the case 120 may be formed in a three-staged structure including a first case, a second case, and a third case. Detailed embodiments of the case 120 are described with reference to FIGS. 3 to 10.

The beading portion 126 is configured to prevent the electrode assembly 110 from moving within the case 120 and to fix positions of the gasket 140 and the cap assembly 130. The clamping portion 128 is configured to fix the cap assembly 130 by pressing the edge of the cap assembly 130 through the gasket 140. The case 120 may include, as a non-limiting example, nickel-plated iron.

The insulating plate 150 may be positioned to be in contact with the electrode assembly 110 below the beading portion 126. The insulating plate 150 may include a tab opening (not shown) for withdrawing the first electrode tab 115. The cap assembly 130, which is electrically connected to the first electrode 112 via the first electrode tab 115, faces the electrode assembly 110 with the insulating plate 150 positioned between the cap assembly 130 and the electrode assembly 110. and the cap assembly 130 may be maintained as being insulated from the electrode assembly 110 via the insulating plate 150.

In an embodiment, the positive electrode corresponding to the first electrode 112 of the secondary battery 100 may include a current collector (not shown) and a positive electrode active material layer (not shown) formed on the current collector. The positive electrode active material layer may include a positive electrode active material and may further include a binder and/or a conductive material (e.g., an electrically conductive material).

The positive electrode active material may include a compound (e.g., lithiated intercalation compound) that is capable of intercalating and/or deintercalating lithium. Specifically, at least one of a composite oxide of lithium and a metal including cobalt, manganese, nickel, or combinations thereof may be used.

The composite oxide may include a lithium transition metal composite oxide. Non-limiting examples of the composite oxide may include lithium nickel-based oxide, lithium cobalt-based oxide, lithium manganese-based oxide, lithium iron phosphate-based compound, cobalt-free nickel-manganese-based oxide, and a combination thereof.

As a non-limiting example, compounds represented by any one of the following chemical formulas may be used as the composite oxide. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α} (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GeO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8), where A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L¹ is Mn, Al, or a combination thereof.

The positive electrode active material may include, as a non-limiting example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol %, and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

As a non-limiting example, the positive electrode may further include an additive that can serve as a sacrificial positive electrode.

An amount of the positive electrode active material may be about 90 wt % to about 99.5 wt % based on 100 wt % of the positive electrode active material layer. Amounts of the binder and the conductive material may each be about 0.5 wt % to about 5 wt % based on 100 wt % of the positive electrode active material layer.

The binder is configured to adhere particles of the positive electrode active material to one another and also to adhere the positive electrode active material to the current collector. Non-limiting examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like.

The conductive material is configured to ensure conductivity (e.g., electrical conductivity) to the electrode. Any material that does not cause chemical change (e.g., does not cause an undesirable chemical change in the rechargeable lithium battery) and readily conducts electrons can be used in the battery. Non-limiting examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

Al may be used as the current collector, but is not limited thereto.

In an embodiment, the negative electrode corresponding to the second electrode 113 of the secondary battery 100 may include a current collector and a negative electrode active material layer positioned on the current collector. The negative electrode active material layer may include a negative electrode active material, and may further include a binder and/or a conductive material (e.g., an electrically conductive material).

The negative electrode active material may include a material that is capable of reversibly intercalating/deintercalating lithium ions, a lithium metal, a lithium metal alloy, a material capable of doping/dedoping lithium, or a transition metal oxide.

The material that is capable of reversibly intercalating/deintercalating lithium ions may include a carbon-based negative electrode active material, such as crystalline carbon, amorphous carbon or a combination thereof. The crystalline carbon may be graphite such as a non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal including Na, K, Rb, Cs, Fr, Be, Mg, Ca, Sr, Si, Sb, Pb, In, Zn, Ba, Ra, Ge, Al, Sn, or a combination thereof.

The material capable of doping/dedoping lithium may include a Si-based negative electrode active material or a Sn-based negative electrode active material. The Si-based negative electrode active material may include silicon, a silicon-carbon composite, SiOx (0<x<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO₂, a Sn-based alloy, or a combination thereof.

The silicon-carbon composite may be a composite of silicon and amorphous carbon. In an embodiment, the silicon-carbon composite may be in a form of silicon particles and amorphous carbon coated on the surface of the silicon particles. As a non-limiting example, the silicon-carbon composite may include a secondary particle (core) in which primary silicon particles are assembled, and an amorphous carbon coating layer (shell) is positioned on the surface of the secondary particle. The amorphous carbon may be positioned between the primary silicon particles. As a non-limiting example, the primary silicon particles may be coated with the amorphous carbon. The secondary particle may be dispersed in an amorphous carbon matrix.

The silicon-carbon composite may further include crystalline carbon. As a non-limiting example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

As a non-limiting example, the negative electrode active material layer may include about 90 wt % to about 99 wt % of the negative electrode active material, about 0.5 wt % to about 5 wt % of the binder, and about 0 wt % to about 5 wt % of the conductive material.

The binder is configured to adhere particles of the negative electrode active material to one another and also to adhere the negative electrode active material to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may include a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, or a combination thereof.

When an aqueous binder is used as the negative electrode binder, a cellulose-based compound, capable of enhancing viscosity, may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may include a polymer material that is capable of being fibrous. As a non-limiting example, the dry binder may be polytetrafluoroethylene, polyvinylidene fluoride, a polyvinylidene fluoride-hexafluoropropylene copolymer, polyethylene oxide, or a combination thereof.

The conductive material is configured to ensure conductivity (e.g., electrical conductivity) to the electrode. Any material that does not cause chemical change (e.g., does not cause an undesirable chemical change in the rechargeable lithium battery) and readily conducts electrons can be used in the battery. Non-limiting examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

The negative current collector may include a copper foil, a nickel foil, a stainless steel foil, a titanium foil, a nickel foam, a copper foam, a polymer substrate coated with a conductive metal, or a combination thereof.

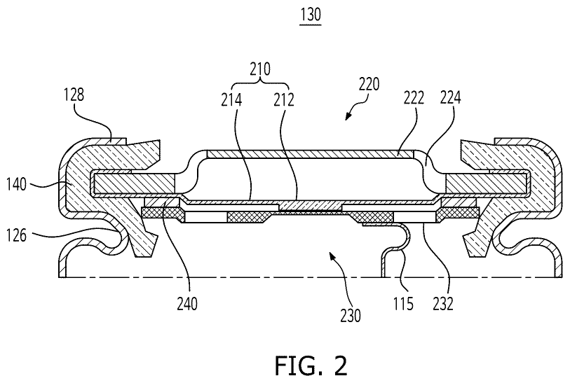

FIG. 2 shows a cap assembly 130 of the secondary battery 100 according to embodiments of the present disclosure.

The cap assembly 130 may include a vent 210, a cap-up 220, a cap-down 230, a beading portion 126, a gasket 140, and a communication hole 232.

In an embodiment, the vent 210 may be positioned above the cap-down 230. The vent 210 may be insulated from the cap-down 230 through an insulating layer 240 positioned on the radially outer upper surface of the cap-down 230. The vent 210 may be positioned to surround a region of the radially outer upper surface of the cap-up 220 and the radially outer surface of the cap-up 220.

In an embodiment, the vent 210 may include a protrusion portion 212 and a rupture portion 214. In an embodiment, the protrusion portion 212 protrudes downward from the center of the vent 210. The protrusion portion 212 may be electrically connected to a first electrode (e.g., the first electrode 112 of FIG. 1) through the first electrode tab 115.

In an embodiment, the rupture portion 214 is configured to be ruptured by the pressure of gas transferred through a plurality of communication holes 232. The rupture portion 214 may have various thicknesses depending on the pressure of the gas at which the rupture portion 214 is to be ruptured. In an embodiment, the rupture portion 214 may have a relatively thin thickness so that the rupture portion 214 is ruptured by the pressure of the gas. The rupture portion 214 may be spaced apart corresponding to each communication hole 232 or may be offset corresponding to each communication hole 232. When the rupture portion 214 is ruptured, the protrusion portion 212 may be separated from the cap-down 230. The vent 210 may have a step configuration so as to be readily separated from the cap-down 230.

In an embodiment, the clamping portion 128 may be formed to surround a region of the radially outer upper surface and the radially outer surface of the cap-up 220. As a non-limiting example, the clamping portion 128 may be formed using a crimping jig (not shown) after the cap-up 220 is fixed to the vent 210. The cap-up 220 may be fixed to the vent 210 via the clamping portion 128.

In an embodiment, a plurality of welding portions (not shown) may be formed on the clamping portion 128. The welding portions may be formed symmetrically relative to the center of the vent 210, but the present disclosure is not limited thereto. Adjacent welding portions may be formed at regular intervals, but the present disclosure is not limited thereto. Welding may be performed on the welding portions so that a welding mark may be formed in a portion where the radially outer upper surface of the cap-up 220 and the vent 210 come into contact with each other.

In an embodiment, the cap-down 230 may be positioned below the vent 210. The cap-down 230 may be have a step configuration corresponding to the shape of the vent 210. An insulating layer 240 may be positioned on a region of the radially outer upper surface of the cap-down 230 to provide insulation from the vent 210. A region of the radially outer lower surface of the cap-down 230 may come into contact with the gasket 140.

In an embodiment, the protrusion portion 212 of the vent 210 may be positioned in the center of the cap-down 230. The cap-down 230 may include a plurality of communication holes 232 spaced apart in the central portion of the cap-down 230. The cap-down 230 and the vent 210 may be electrically connected to the first electrode (e.g., the first electrode 112 of FIG. 1) via the first electrode tab 115.

In an embodiment, the communication holes 232 may be spaced apart from one another in the central portion of the cap-down 230. Gases formed inside the secondary battery 100 may communicate through the communication holes 232. The rupture portion 214 of the vent 210 may be positioned corresponding to each of the communication holes 232. In some embodiments, the rupture portion 214 of the vent 210 may be offset corresponding each of the communication holes 232. As a non-limiting example, during charging and discharging of the secondary battery 100, the electrolyte may be decomposed to form gas. The formed gas may communicate through the communication holes 232 formed in the cap-down 230. The rupture portion 214 of the vent 210 may be ruptured by receiving pressure from the gas communicating through the communication holes 232.

In an embodiment, the cap-up 220 may be positioned above the vent 210. A region of the radially outer surface and the radially outer upper surface of the cap-up 220 may be surrounded and fixed by the vent 210. The cap-up 220 may protrude upward and have a step configuration. The cap-up 220 may protrude upward and may be spaced apart from the vent 210. When the vent 210 is ruptured, the protrusion portion 212 of the vent 210 may be separated from the cap-down 230 and may be repositioned to a space where the cap-up 220 and the vent 210 are spaced apart.

In an embodiment, the cap-up 220 may include a terminal portion 222 and a plurality of discharge holes 224. In an embodiment, the terminal portion 222 may be connected to an external terminal. The cap-up 220 may be electrically connected to the first electrode 112 via the first electrode tab 115, the cap-down 230, and the vent 210. The cap-up 220 may be configured to function as the first electrode 112, and the terminal portion (222) may be connected to the external terminal.

In an embodiment, the discharge holes 224 may discharge gas transferred through the rupture portion 214 of the vent 210. The rupture portion 214 of the vent 210 may be ruptured by the pressure of the gas, and the discharge holes 224 may discharge the gas.

In an embodiment, the insulating layer 240 may be positioned between the cap-down 230 and the vent 210. In addition to the configuration in which the vent 210 and the cap-down 230 are connected via the protrusion portion 212, the insulating layer 240 may be positioned on the radially outer upper surface of the cap-down 230 to insulate the vent 210 and the cap-down 230 so that the vent 210 and the cap-down 230 do not come into contact with each other. The cap-down 230 and the vent 210 may be electrically connected to the first electrode (e.g., the first electrode 112 of FIG. 1) via the first electrode tab 115.

In an embodiment, the gasket 140 may radially surround the cap assembly 130 and may be positioned between the case 120 and the cap assembly 130. As a non-limiting example, the gasket 140 may be positioned on one side of the case 120 forming a ring shape. The gasket 140 may electrically insulate the cap assembly 130 connected to the first electrode (e.g., the first electrode 112 of FIG. 1) and the case 120 connected to the second electrode (e.g., the second electrode 113 of FIG. 1). In addition, the gasket 140 may protect the cap assembly 130 by buffering external impact.

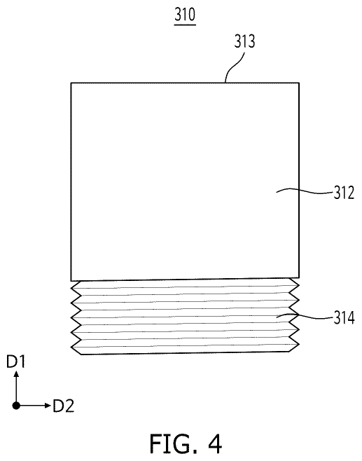

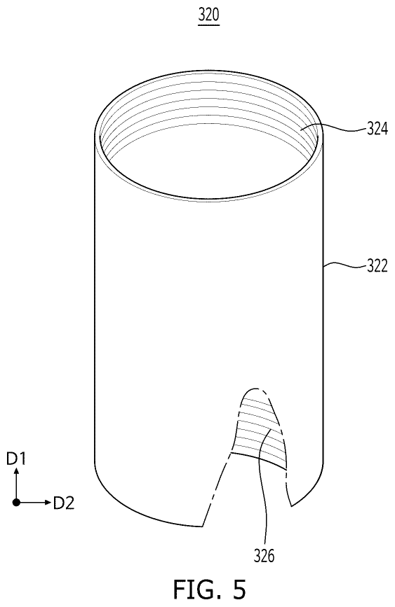

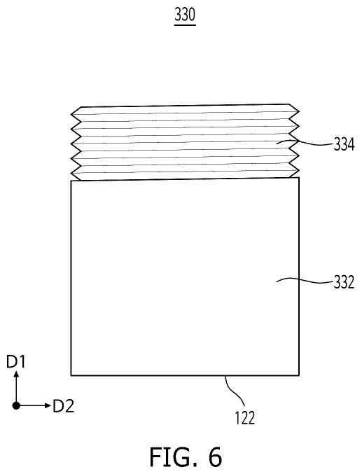

FIG. 3 shows a case 120 of the secondary battery 100 according to embodiments of the present disclosure. FIG. 4 shows a first case 310 according to embodiments of the present disclosure. FIG. 5 shows a second case 320 according to embodiments of the present disclosure. FIG. 6 shows a third case 330 according to embodiments of the present disclosure.

Referring to FIGS. 3 to 6, the case 120 may include a first case 310, a second case 320, and a third case 330. In an embodiment, the first case 310 may include a first body portion 312 and a first fastening portion 314 formed at one end of the first body portion 312. An opening 313 may be formed at the other end of the first body portion 312, and the cap assembly 130 may be positioned on the opening 313 to form the upper portion of the case 120.

The first fastening portion 314 may have a thread structure so that the first case 310 may be fastened to any configuration in a screwed manner. In an embodiment, the first fastening portion 314 has a thread structure formed on the outer circumferential surface of the first case 310, but may also have a thread structure formed on the inner circumferential surface of the first case 310. The interval or pitch of each screw thread may have a length greater than or equal to a certain ratio of the length of the first fastening portion 314. As a non-limiting example, the interval between the screw threads may be at least 20% of the length of the first fastening portion 314. Accordingly, the first case 310 may be readily fastened to or released from any configuration.

In an embodiment, the material of the first body portion 312 may be different from the material of the first fastening portion 314. As a non-limiting example, the first body portion 312 may include at least one of cold rolled steel plate (e.g., SPCE), aluminum (AI), an aluminum alloy, or steel. In some embodiments, the surface of the first body portion 312 may be film-coated. As a non-limiting example, the wear resistance of the first body portion 312 may be improved by coating a polycarbonate film on the surface of the first body portion 312.

As a non-limiting example, the first fastening portion 314 may include cold rolled steel plate (e.g., SPCE), stainless use steel (SUS), or tungsten (W). By adopting a high-strength material with a low coefficient of friction in the first fastening portion 314, wear of the thread structure may be minimized during screw connection and damage may be minimized during disassembly.

In an embodiment, the length of the first case 310 may be less than or equal to 25% of the length of the case 120. The length of the first body portion 312 in a first direction D1 may be greater than the length of the first fastening portion 314 in the first direction D1. In some embodiments, the length of the first body portion 312 in the first direction D1 may be at least twice the length of the first fastening portion 314 in the first direction D1.

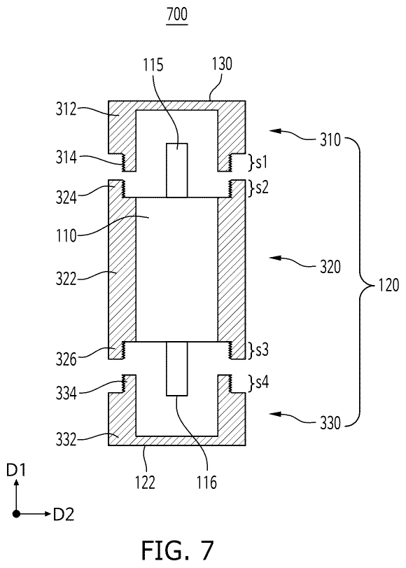

The second case 320 may include a second body portion 322, a second fastening portion 324 formed at one end of the second body portion 322, and a third fastening portion 326 formed at the other end of the second fastening portion 324. The case 120 having a three-stage structure may be formed by joining the first case 310 to one end of the second case 320 via the second fastening portion 324 and joining the third case 330 to the other end of the second case 320 via the third fastening portion 326. A detailed embodiment thereof is described with reference to FIG. 7.

The second fastening portion 324 and/or the third fastening portion 326 may have a thread structure so that the second fastening portion 324 or the third fastening portion 326 may be fastened to any configuration in a screwed manner. In an embodiment, the second fastening portion 324 and/or the third fastening portion 326 has a thread structure formed on the inner circumferential surface of the second case 320, but may also have a thread structure formed on the outer circumferential surface of the second case 320. The interval or pitch of each screw thread may have a length greater than or equal to a certain ratio of the length of the second fastening portion 324 or the third fastening portion 326. As a non-limiting example, the interval between the screw threads may be at least 20% of the length of each of the second fastening portion 324 and the third fastening portion 326. Accordingly, the second case 320 may be readily fastened to or released from any configuration.

In an embodiment, the material of the second body portion 322 may be different from the materials of the first body portion 312 and the third body portion 332. The material of the second body portion 322 may be different from the materials of the second fastening portion 324 and/or the third fastening portion 326. As a non-limiting example, the second body portion 322 may include at least one of alloy tool steel (e.g., SKD11), high-speed tool steel (e.g., SKH51), powdered high-speed tool steel (e.g., SKH40), cemented carbide (e.g., V30), cold rolled steel plate (e.g., SPCE), aluminum, aluminum alloy, and stainless steel. By adopting such a wear-resistant material, the chemical stability of the second body portion 322 may be improved. In an embodiment, the surface of the second body portion 322 may be film-coated. As a non-limiting example, the wear resistance of the second body portion 322 may be improved by coating a polycarbonate film on the surface of the second body portion 322.

The second fastening portion 324 and/or the third fastening portion 326 may include cold rolled steel plate (e.g., SPCE), stainless steel, or tungsten. By adopting a high-strength material with a low coefficient of friction in the second fastening portion 324 and/or the third fastening portion 326, wear of the thread structure may be minimized during screw connection and damage may be minimized during disassembly.

In an embodiment, the length of the second case 320 may be greater than or equal to 25% of the total length of the case 120. The length of the second body portion 322 in the first direction D1 may be greater than the length of the second fastening portion 324 or the third fastening portion 326 in the first direction D1. In some embodiments, the length of the second body portion 322 in the first direction D1 may be at least twice the length of the second fastening portion 324 or the third fastening portion 326 in the first direction D1.

The third case 330 may include a third body portion 332 and a fourth fastening portion 334 formed at one end of the third body portion 332. The third case 330 may include a bottom portion 122 that seals the other end of the third case 330. Accordingly, the third case 330 may form the lower portion of the case 120.

The fourth fastening portion 334 may have a thread structure so that the third case 330 may be fastened to any configuration in a screwed manner. In an embodiment, the fourth fastening portion 334 has a thread structure formed on the outer circumferential surface of the third case 330, but may also have a thread structure formed on the inner circumferential surface of the third case 330. The interval or pitch of each screw thread may have a length greater than or equal to a certain ratio of the length of the fourth fastening portion 334. As a non-limiting example, the interval between the screw threads may be at least 20% of the length of the fourth fastening portion 334. Accordingly, the third case 330 may be easily fastened to or released from any configuration.

In an embodiment, the material of the third body portion 332 may be different from the material of the fourth fastening portion 334. As a non-limiting example, the third body portion 332 may include at least one of cold rolled steel plate (e.g., SPCE), aluminum (AI), an aluminum alloy, or steel. In some embodiments, the surface of the third body portion 332 may be film-coated. As a non-limiting example, the wear resistance of the third body portion 332 may be improved by coating a polycarbonate film on the surface of the third body portion 332.

As a non-limiting example, the fourth fastening portion 334 may include cold rolled steel plate (e.g., SPCE), stainless use steel (SUS), or tungsten (W). By adopting a high-strength material with a low coefficient of friction in the fourth fastening portion 334, wear of the thread structure may be minimized during screw connection and damage may be minimized during disassembly.

In an embodiment, the length of the third case 330 may be less than or equal to 25% of the length of the case 120. The length of the third body portion 332 in the first direction D1 may be greater than the length of the fourth fastening portion 334 in the first direction D1. In some embodiments, the length of the third body portion 332 in the first direction D1 may be at least twice the length of the fourth fastening portion 334 in the first direction D1.

By adjusting the length or thickness, etc. between the components of the first case 310, the second case 320, and the third case 330, it is possible to set optimal conditions required for disassembly analysis of the secondary battery 100.

FIG. 7 shows a secondary battery 700 according to embodiments of the present disclosure.

The secondary battery 700 may include an electrode assembly 110 and a case 120 that accommodates the electrode assembly 110 within. The case 120 may include a first case 310 including a first body portion 312 and a first fastening portion 314 formed at one end of the first body portion 312, a second case including a second body portion 322, a second fastening portion 324 formed at one end of the second body portion 322 and fastened to the first fastening portion 314 of the first case 310, and a third fastening portion 326 formed at the other end of the second body portion 322, and a third case 330 including a third body portion 332 and a fourth fastening portion 334 formed at one end of the third body portion 332 and fastened to the third fastening portion 326 of the second case 320.

In an embodiment, the first fastening portion 314 may have a first thread structure s1, the second fastening portion 324 may have a second thread structure s2 corresponding to the first thread structure s1 of the first fastening portion 314, and the first thread structure s1 and the second thread structure s2 may be fastened in a screwed manner so that the first case 310 and the second case 320 may be coupled to each other.

The third fastening portion 326 may have a third thread structure s3, the fourth fastening portion 334 may have a fourth thread structure s4 corresponding to the third thread structure s3, and the third thread structure s3 and the fourth thread structure s4 may be fastened in a screwed manner so that the second case 320 and the third case 330 may be coupled to each other. In this manner, the first case 310, the second case 320, and the third case 330 may collectively form the case 120 of the secondary battery 700.

By having the secondary battery 700 including the three-stage screw-fastened case 120, the disassembly of the secondary battery 700 may be readily and safely performed and damage to the electrode assembly 110 and the secondary battery 700 may be prevented. In addition, rapid disassembly of the secondary battery 700 is possible, thereby preventing deformation (e.g., drying of the electrode plates, loss of active material, etc.) that may occur when the electrode assembly 110 is exposed to the exterior environment.

In an embodiment, the electrode assembly 110 may include a first electrode tab 115 extending in the first direction D1, and at least a portion of the first electrode tab 115 may overlap with the second fastening portion 324 in the second direction D2. That is, the electrode assembly 110 may formed by being wound in the same winding axis direction (i.e., the first direction D1), and at least a portion of the first electrode tab 115 may overlap the second fastening portion 324 in a direction perpendicular to the winding axis (i.e., the second direction D2). The electrode assembly 110 may include a second electrode tab 116 extending opposite to the first direction D1, and at least a portion of the second electrode tab 116 may overlap the third fastening portion 326 in the second direction D2. That is, the electrode assembly 110 may formed by being wound in the same winding axis direction (i.e., the first direction D1), and at least a portion of the second electrode tab 116 may overlap the third fastening portion 326 in a direction perpendicular to the winding axis (i.e., the second direction D2). The first electrode tab 115 and the second electrode tab 116 included in the electrode assembly 110 are respectively positioned near the second fastening portion 324 and the third fastening portion 326 of the case 120, so that the first electrode tab 115 and the second electrode tab 116 may be cut when disassembling the secondary battery 700.

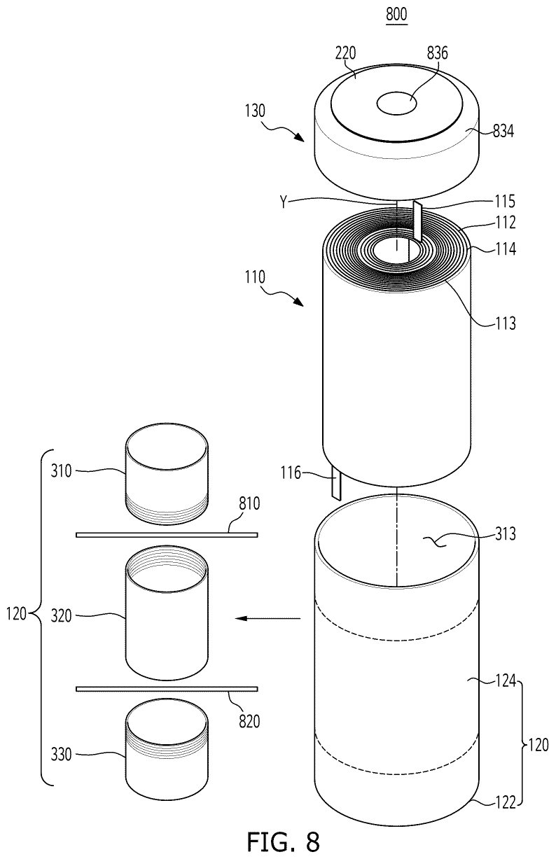

FIG. 8 is an exploded perspective view of a secondary battery 800 including a case 120 according to embodiments of the present disclosure.

The secondary battery 800 may include a case 120, an electrode assembly 110, and a cap assembly 130. The case 120 may include a bottom portion 122, a sidewall portion 124 connected to the bottom portion 122, and an upper end opening 313 on the opposite end of the bottom portion 122. The case 120 is configured to accommodate the electrode assembly 110 through the upper end opening 313. The upper end may refer to one end where the cap assembly 130 is positioned in the longitudinal direction of the secondary battery 800. Similarly, the lower end may refer to an opposite end of the upper end in the longitudinal direction of the secondary battery 800.

The electrode assembly 110 may include a separator 114, and a first electrode 112 and a second electrode 113, where the separator 114 is positioned between the first electrode 112 and the second electrode 113. The electrode assembly 110 may be wound in a jelly-roll shape relative to a winding axis Y.

The first electrode 112 may include a first substrate and a first active material layer positioned on the first substrate. In a first uncoated portion of the first substrate where the first active material layer is absent, a first electrode tab 115 may extend from one end of the first uncoated portion in the direction of the winding axis Y. The first electrode tab 115 may be electrically connected to the cap assembly 130.

The second electrode 113 may include a second substrate and a second active material layer positioned on the second substrate. In a second uncoated portion of the second substrate, where the second active material layer is absent, a second electrode tab 116 may extend from one end of the second uncoated portion in the direction of the winding axis Y. The second electrode tab 116 may be electrically connected to the case 120.

In an embodiment, the case 120 may be a substantially cylindrical case. The case 120 may be a case 120 with a three-stage structure according to embodiments of the present disclosure. As a non-limiting example, the case 120 may include a first case 310, a second case 320, and a third case 330. A first electrode tab 115 may be positioned in the case 120 to axially overlap a first line 810, and a second electrode tab 116 may be positioned in the case 120 to axially overlap a second line 820. Accordingly, when disassembling the secondary battery 800, the first electrode tab 115 and the second electrode tab 116 may be cut.

The cap assembly 130 may include a cap-up 220, an insulating member 834, and an electrolyte injection port 836. The cap-up 220 may be electrically connected to the first electrode 112 of the electrode assembly 110. That is, the first electrode 112 of the electrode assembly 110 may be electrically connected to the cap assembly 130. The second electrode 113 of the electrode assembly 110 may be electrically connected to the case 120.

The insulating member 834 may positioned to insulate the cap-up 220 from the case 120. As a non-limiting example, the insulating member 834 may be formed to radially surround the cap-up 220, but the present disclosure is not limited thereto, and various shapes may be used as long as the insulating member 834 may insulate between the cap-up 220 and the case 120.

The electrolyte injection port 836 is configured to pass electrolytes through the cap assembly 130. As a non-limiting example, the electrolyte injection port 836 is configured to pass electrolytes through the cap-up 220. An electrolyte may be injected into the secondary battery 800 through the electrolyte injection port 836, and gas generated inside the secondary battery 800 may be discharged through the electrolyte injection port 836.

The secondary battery 800 may be a lithium secondary battery, a sodium secondary battery, etc. However, the scope of the present disclosure is not limited thereto, and the secondary battery 800 may include any battery that is capable of repeatedly providing electricity through charging and discharging.

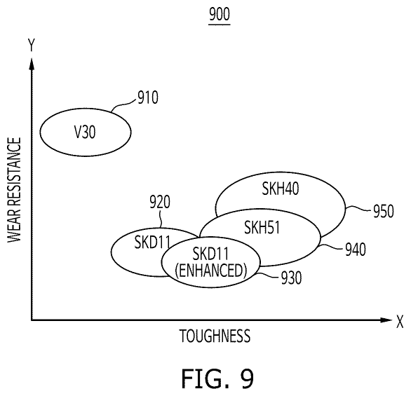

FIG. 9 shows a toughness-wear resistance graph 900 of materials according to embodiments of the present disclosure.

The horizontal axis X of the graph 900 represents the toughness of the materials and indicates greater toughness in the right hand side direction. The vertical axis Y represents the wear resistance of the materials and indicates greater wear resistance in the upward direction. V30 910, which is a type of cemented carbide, has the greatest wear resistance but the lowest toughness. SKD11 920 and enhanced SKD11 930, both of which are types of alloy tool steel, have greater toughness than V30 910. SKH51 940, which is a type of high-speed tool steel, has greater toughness and wear resistance than SKD11 920 and enhanced SKD11 930. SKH40 950, which is a type of powdered high-speed tool steel, has greater toughness and wear resistance than SKH51 940.

The material of the second body portion may include at least one of alloy tool steel (e.g., SKD11), high-speed tool steel (e.g., SKH51), powdered high-speed tool steel (e.g., SKH40), cemented carbide (e.g., V30), cold rolled steel plate (e.g., SPCE), aluminum, aluminum alloy, or stainless steel.

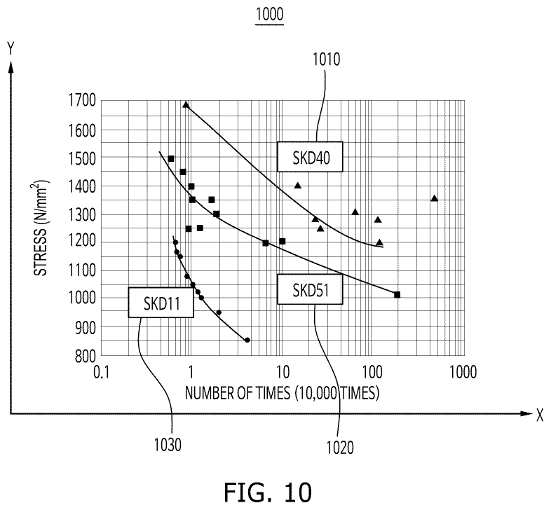

FIG. 10 is an SN curve 1000 of materials according to embodiments of the present disclosure.

The horizontal axis X represents the number of times stress is repeated in a fatigue test and indicates that more stress is repeated in the right hand side direction. The vertical axis Y represents the stress (unit: N/mm²) applied to the material and indicates that greater stress is applied in the upward direction. The curves shown by materials 1010, 1020, 1030 in the SN curve 1000 indicate how many times the same value of stress must be applied to the material before the material is damaged when a constant value of stress is applied to the material. As a non-limiting example, when a stress (e.g., torsional stress) of 1,200 N/mm² is applied to SKD11 1030, SKD11 1030 may not be damaged until the same magnitude of stress is repeated for about 7,000 times to 9,000 times.

Referring to FIGS. 5 and 10, the material of the second body portion 322 of the second case 320 may include SKD11 1030. As a non-limiting example, when the second case 320 is cylindrical and is fastened in a screwed manner by the second fastening portion 324, the torsional stress applied to the second case 320 may be calculated by the following equation.

$$τ = \frac{T \times ρ}{J} ( J = \frac{π {r}^{4}}{2} ) \qquad [ Equation 1 ]$$

where τ is the torsional stress, T is the torque, ρ is the radius of the second case 320, and J is the polar moment of inertia of the second case 320.

As a non-limiting example, when the diameter of the cylindrical second case 320 is 21 mm and the torque applied in a case of being fastened is 250 N·m, the torsional stress applied to the second case 320 when being fastened with a screw is approximately 157 N/mm². Accordingly, even when SKD11 1030, which has the least fatigue limit, is employed as the material of the second case 320, the fastening and disassembly of the second case 320 may be repeated permanently.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

What is claimed is:

1. A case for a secondary battery, comprising:
a first case comprising a first body portion and a first fastening portion, the first fastening portion positioned at one end of the first body portion;
a second case comprising a second body portion, a second fastening portion, the second fastening portion positioned at one end of the second body portion and configured to be coupled to the first fastening portion of the first case, and a third fastening portion, the third fastening portion positioned at an opposite end of the second body portion; and
a third case comprising a third body portion and a fourth fastening portion, the fourth fastening portion formed at one end of the third body portion and configured to be coupled to the third fastening portion of the second case.

2. The case as claimed in claim 1, wherein the first fastening portion has a first thread structure and the second fastening portion has a second thread structure corresponding to the first thread structure.

3. The case as claimed in claim 1, wherein the third fastening portion has a third thread structure and the fourth fastening portion has a fourth thread structure corresponding to the third thread structure.

4. The case as claimed in claim 1, wherein the second body portion comprises a material different from materials of the first body portion and the third body portion.

5. The case as claimed in claim 1, wherein the first body portion comprises a material different from a material of the first fastening portion, the second body portion comprises a material different from materials of the second fastening portion and the third fastening portion, and the third body portion comprises a material different from a material of the fourth fastening portion.

6. The case as claimed in claim 1, wherein the second body portion comprises at least one selected from the group of alloy tool steel, high-speed tool steel, powdered high-speed tool steel, cemented carbide, cold rolled steel plate, aluminum, aluminum alloy, and stainless steel.

7. The case as claimed in claim 1, wherein the first fastening portion comprises at least one selected from the group of cold rolled steel plate, stainless steel, and tungsten.

8. The case as claimed in claim 1, wherein the first fastening portion is surface-coated with at least one selected from the group of chromium, carbon, molybdenum, tungsten, and vanadium.

9. The case as claimed in claim 1, wherein the third case comprises a bottom portion configured to seal an opposite end of the third body portion.

10. A secondary battery comprising:
an electrode assembly comprising a first electrode, a second electrode, and a separator positioned between the first electrode and the second electrode; and
a case configured to accommodate the electrode assembly, the case comprising:
a first case comprising a first body portion and a first fastening portion, the first fastening portion positioned at one end of the first body portion;
a second case comprising a second body portion, a second fastening portion, the second fastening portion positioned at one end of the second body portion and configured to be coupled to the first fastening portion of the first case, and a third fastening portion, the third fastening portion positioned at an opposite end of the second body portion; and
a third case comprising a third body portion and a fourth fastening portion, the fourth fastening portion formed at one end of the third body portion and configured to be coupled to the third fastening portion of the second case.

11. The secondary battery as claimed in claim 10, wherein the first fastening portion has a first thread structure and the second fastening portion has a second thread structure corresponding to the first thread structure.

12. The secondary battery as claimed in claim 10, wherein the third fastening portion has a third thread structure and the fourth fastening portion has a fourth thread structure corresponding to the third thread structure of the third fastening portion.

13. The secondary battery as claimed in claim 10, wherein each of the first electrode, the second electrode, and the separator is in a wound configuration relative to a winding axis,
wherein the first electrode comprises a first electrode tab extending in a direction of the winding axis, and
wherein at least a portion of the first electrode tab overlaps the second fastening portion in a direction perpendicular to the winding axis.

14. The secondary battery as claimed in claim 13, further comprising a cap assembly positioned on an opening formed at an opposite end of the first body portion,
wherein the first electrode tab is in contact with the cap assembly.

15. The secondary battery as claimed in claim 10, wherein each of the first electrode, the second electrode, and the separator is in a wound configuration relative a winding axis,
wherein the second electrode comprises a second electrode tab extending in a direction of the winding axis, and
wherein at least a portion of the second electrode tab overlaps the third fastening portion in a direction perpendicular to the winding axis.

16. The secondary battery as claimed in claim 15, wherein the third case comprises a bottom portion formed at an opposite end of the third body portion and wherein the second electrode tab is in contact with the bottom portion.

17. The secondary battery as claimed in claim 10, wherein the second body portion comprises at least one selected from the group of alloy tool steel, high-speed tool steel, powdered high-speed tool steel, cemented carbide, cold rolled steel plate, aluminum, aluminum alloy, and stainless steel.

18. The secondary battery as claimed in claim 10, wherein the second case is film-coated.

19. The secondary battery as claimed in claim 10, wherein the first fastening portion comprises at least one selected from the group of cold rolled steel plate, stainless steel, and tungsten.

20. The secondary battery as claimed in claim 10, wherein the first fastening portion is surface-coated with at least one selected from the group of chromium, carbon, molybdenum, tungsten, or vanadium.
